(19) United States
(12) Patent Application Publication
(10) Pub. No.: US 2006/0209772 A1
(43) Pub. Date: Sep. 21, 2006

(54) Coordinated directional medium access control in a wireless network

(75) Inventors: Yuguang Michael Fang, Gainesville, FL (US); Jianfeng Wang, Gainesville, FL (US); Dapeng Oliver Wu, Gainesville, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC., GAINESVILLE, FL (US)

(21) Appl. No.: 11/080,041

(22) Filed: Mar. 15, 2005

(51) Int. Cl. H04Q 7/24

(52) U.S. Cl. 370/338; 370/445

(57) ABSTRACT

A method of simultaneously transmitting and receiving multiple data packets over wireless channels among the nodes of a wireless network is provided. The method includes automatically selecting a master sending node and corresponding master receiving node in response to an omni-directionally transmitted request to send during a contention period. The method also includes selecting a slave sending node and corresponding slave receiving node if a spatial reuse ratio correspond to the master-node pair is less than a predetermined threshold and if directional data transmissions between the slave sending node and corresponding slave receiving node avoid interfering with directional data transmissions between the master nodes and other pairs of slave nodes. The method further includes causing the master sending node and slave sending node to directionally transmit data packets during a coordination period.

### STATEMENT REGARDING FEDERALLY SPONSORED RESEARCH OR DEVELOPMENT

Research related to this invention was funded at least in part by the U.S. Office of Naval Research under Young Investigator Award N000140210464. The U.S. Government may have certain rights in the invention.

### CROSS-REFERENCE TO RELATED APPLICATIONS

Not applicable.

### BACKGROUND

1. Field of the Invention

The present invention is related to the field of electronic communications, and, more particularly, to wireless electronic communications

2. Description of the Related Art

The transmission and reception of a wireless signal is generally characterized as being either omni-directional or directional. An omni-directional signal radiates outwardly in a 360-degree range, the signal being emitted by an omni-directional antenna. By contrast, a directional signal emitted by a directional antenna travels in a specific beam direction with a particular beamwidth.

The transmission and reception of directional signals affords distinct advantages over omni-directional ones. The advantages afforded by directional transmission and reception include increased antenna gain and higher spatial reuse ratio, the latter measure being approximated by the number of non-colliding directional signals that can be transmitted or received given a specific beam width of each directional signal in a local area. Accordingly, the transmission and reception of directional signals via directional-capable antennas provides greater throughput and energy efficiency relative to that achieved with the transmission and reception of omni-directional signals via omni-directional antennas.

Despite these definite advantages, the use of directional signals and directional-capable antennas in ad hoc wireless networks remains highly problematic. The transmission and reception of directional signals via directional-capable antennas in such a network poses several as-yet-unsolved problems. One problem is the so-called deafness problem, which can be defined in various ways but generally arises when a transmitting node fails to communicate with an intended receiving node because the receiving node is beamformed in a direction away from the transmitting node.

The deafness problem can cause energy to be wasted and network capacity to be squandered in a wireless ad hoc network as a result of network nodes engaging in repeated, unproductive transmissions. The deafness problem also can degrade the performance of communication systems operating in accordance with conventional routing protocols and transport protocols such as the TCP. For example, the deafness problem can cause false link-breakage indications in the routing layer and lessen the stability of end-to-end congestion control. One or more of these problems if sufficiently serious and left unaddressed can more than offset the advantages that could otherwise be gained through the use of directional antennas in wireless ad hoc networks.

Yet another obstacle to utilizing directional transmissions and receptions in a wireless ad hoc network is the hidden-terminal problem whereby a deaf node transmits an RTS signal in the same beam direction as is being used for an on-going communication between another pair of nodes. The hidden-terminal condition is a long-recognized problem that arises even in ad hoc wireless networks whereby nodes communicate with one another using only omni-directional antennas. The problem can be even more severe if directional antennas are employed in such networks, with the result that an ad hoc wireless network using directional antennas may perform less effectively and less efficiently than one using only omni-directional antennas.

Another obstacle to using directional antennas in wireless ad hoc networks is the exposed-terminal problem. An exposed terminal is a node that can sense an RTS/CTS exchange between a pair of other nodes and that, as a result, refrains from transmitting even though its own transmission would not collide with that of the other nodes. Such deferrals of non-colliding transmissions can reduce spatial reuse in the network substantially.

Still another obstacle is the side lobe problem. Side lobes are generally that portion of the electromagnetic response pattern of an antenna that is not contained in the main beam of a directional signal. The problem can arise if one node senses the RTS/CTS exchange of a pair of other nodes and decides that, since its own anticipated transmission to yet another node will not collide with the beam of the communicating pair of nodes, it can transmit a collision-free signal to the other node. The problem occurs if the deciding node is in such close proximity to one of the two communicating nodes that a side lobe of the signal from the deciding node interferes with the signal between the communicating nodes.

Yet another obstacle to using directional antennas in wireless ad hoc networks concerns the inefficient use of the directional antenna gain and channel gain realized from such use. As already noted, directional transmission and reception can increase total antenna gain relative to that of omni-directional transmission and reception. In addition, short transmission distances between communicating nodes can lead to low path loss, which, in turn increase antenna and/or channel gains that translate into greater energy efficiency and enhanced data rates. These advantages can be lost or wasted, however, if the network is not capable of responding to such conditions by increasing transmission data rates or reducing transmission power.

An overriding consideration in attempting to address each of these problems, moreover, is how to avoid substantial increases in signaling overhead. For example, one proposed solution to the deafness problem is the use of circular directional RTS/CTS signaling. Although this proposed solution potentially alleviates the deafness and hidden-terminal problems, it nonetheless can result in a concommitant increase in signaling overhead. Unless each of the above problems is overcome without undue increases in signaling overhead, the successful utilization of directional antennas for directional transmission and reception in wireless ad hoc networks is likely to remain an elusive goal.

### SUMMARY OF THE INVENTION

The present invention provides a method, system, and article of manufacture that achieve within a wireless ad hoc network the advantages of directional transmission and reception—higher throughput, increased energy efficiency, and greater spatial reuse—while maintaining low signaling overhead. The method, system, and article of manufacture are based on a coordinated directional medium access control (CDMAC) protocol, a key feature of which is the introduction of a time-frame structure that facilitates the simultaneous transmission and simultaneous reception of multiple data packets in a wireless ad hoc network.

The time-frame structure can comprise a contention period followed by a coordination period. In the contention period, a node seeking to transmit a data packet to another node can omni-directionally transmit a request-to-send (RTS). A node seeking to receive a data packet from a corresponding node desiring to transmit a data packet can omni-directionally transmit a clear-to-send (CTS) in response to a received RTS. The RTS and CTS can each comprise omni-directionally transmitted control frames. The RTS-CTS exchange between a pair of nodes serves to reserve channels for subsequent transmissions of data packets and corresponding acknowledgements between nodes. Data packets can be directionally transmitted during the subsequent coordination period. Acknowledgements following receipt of the data packets also can be directionally transmitted during the coordination period.

In one embodiment, the time-frame structure can be configured to facilitate the transmission and reception of data packets in a non-synchronized ad hoc network. According to this embodiment, the contention period can comprise a single-phase master contention period during which a master-node pair can be selected in response to omni-directionally transmitted RTS and CTS. Once the master-node pair is selected, the master nodes determine the timing of the subsequent coordination period, which defines a three-phase master coordination period. The master nodes can determine the end time of the first phase of the master coordination period, during which one or more slave-node pairs is selected also in response to omni-directionally transmitted RTS and CTS. The master nodes can further determine the duration of the second and third phases of the master coordination period. During the second phase, data packets are simultaneously directionally transmitted by a master and at least one slave sending node, and during the subsequent third phase acknowledgements of receipt of data packets are simultaneously directionally transmitted by a master and at least one slave receiving node.

According to yet another embodiment, the time-frame structure can be configured to facilitate the transmission and reception of data packets in a synchronized ad hoc network. The time-frame structure can comprise a two-phase contention period followed by a two-phase coordination period. In this embodiment, a master-node pair is selected in the first phase of the coordination period, during which each active node pair omni-directionally transmits an RTS and CTS. One or more slave-node pairs are selected during the second phase when each remaining active node pair omni-directionally transmits an RTS and CTS. Multiple data packets are simultaneously and directionally transmitted during the first phase of the coordination period, and multiple acknowledgments are simultaneously and directionally transmitted during the second phase of the coordination period. In the synchronized ad hoc network, the beginning and ending times of the contention period as well as the beginning and ending times of each phase of the coordination period are predetermined.

More particularly, a method according to one embodiment of the present invention provides for the coordination of the transmitting and receiving of data packets over wireless channels by a plurality of nodes defining a wireless network. The method can include automatically selecting from among the plurality of nodes a master sending node and corresponding master receiving node in response to an omni-directionally transmitted request to send during a contention period.

The method also can include selecting from among remaining ones of the plurality of nodes at least one slave sending node and at least one corresponding slave receiving node if a spatial reuse ratio associated with the master-node pair is less than a predetermined threshold and if directional data transmissions between the slave sending node and corresponding slave receiving node avoid interfering with directional data transmissions between the master nodes and other pairs of slave nodes. The selecting of at least one slave sending node and corresponding slave receiving node can occur during a first phase of a coordination period. The method further can include causing the master sending node and at least one slave sending node to each directionally transmit at least one data packet during a second phase of the coordination period.

Another embodiment of the present invention provides a system for wirelessly transmitting and receiving data packets in a wireless network. The system can include a master sending node and corresponding master receiving node automatically selected from a plurality of nodes during a contention period. During the contention period, the master sending node can omni-directionally transmit a request-to-send frame. The master receiving node can respond to the request-to-send frame by omni-directionally transmitting a clear-to-send frame during the contention period.

The system also can include at least one slave sending node and at least one corresponding slave receiving node selected from others of the plurality of nodes. At least one slave sending node can omni-directionally transmit another request-to-send frame and the corresponding slave receiving node can respond by omni-directionally transmitting another clear-to-send frame. The master sending node and at least one slave node can be configured to directionally transmit at least one data packet each the master sending node and at least one slave sending node, respectively, during a coordination period.

An article of manufacture according to still another embodiment of the present invention can include a set of control frames that are embodied in carrier signals. The control frames can include a request-to-send (RTS) frame. The control frames further can include a clear-to-send (CTS) frame. The RTS and CTS frames can each comprise a coordinated directional medium access control (CDMAC) extension. The CDMAC extension can be based upon a time-frame structure comprising a contention period and a coordination period.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of an exemplary ad hoc network featuring a system based upon coordinated directional access medium control according to one embodiment of the invention.

FIG. 2 is a schematic diagram of a coordinated directional medium access control time-frame structure according to another embodiment of the present invention.

FIG. 3 is a schematic diagram of an RTS frame that includes a coordinated directional medium access control portion according to still another embodiment of the invention.

FIG. 4 is a schematic diagram of a CTS frame that includes a coordinated directional medium access control portion according to yet another embodiment of the invention.

FIG. 5 is a schematic diagram of a coordinated directional medium access control time-frame structure according to still another embodiment of the invention.

### DETAILED DESCRIPTION OF THE INVENTION

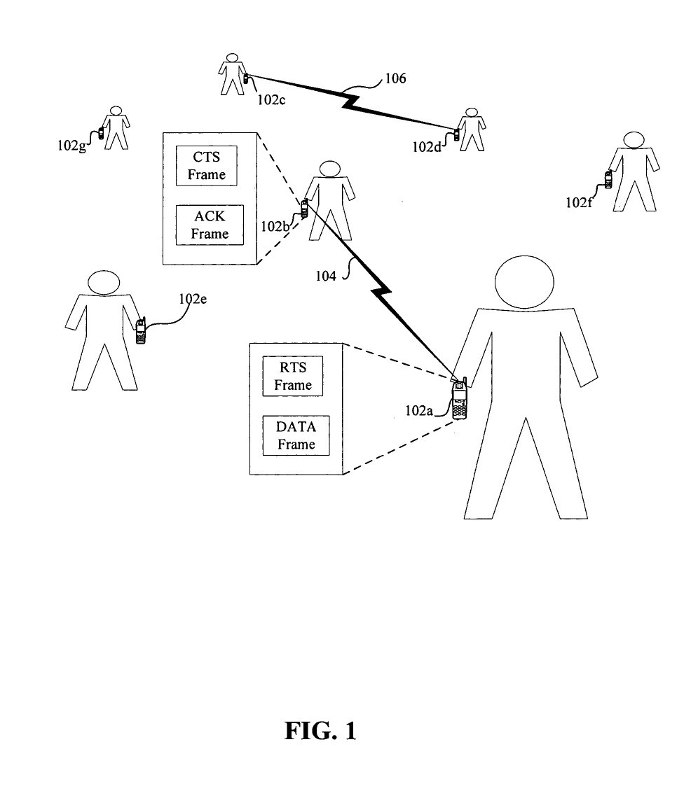

FIG. 1 provides a schematic diagram of a system 100 for wirelessly transmitting and receiving data packets, according to one embodiment of the present invention. The system 100 illustratively comprises a plurality of nodes, including a master sending node 102a and corresponding master receiving node 102b. The system 100 also illustratively includes another pair of nodes defining a slave sending node 102c and corresponding slave receiving node 102d. Illustratively, the system includes yet additional nodes 102e, 102f, 102g, any pair of which can define an additional slave sending node and corresponding additional slave receiving node selected as described more particularly below. As will be apparent from the ensuing discussion the system 100 can include still other nodes in addition to those shown. In the aggregate the nodes 102a-g define an ad hoc communication network.

Each of the exemplary nodes 102a-g of the system 100 is a communications node having the capabilities to wirelessly transmit and receive data packets. Illustratively, each of the master nodes 102a, 102b the slave nodes 102c, 102d, and other nodes 102e-g comprises a mobile terminal having a directional-antenna capability. Note, however, that in an alternative embodiment, the wireless ad hoc communication network can additionally include some nodes that are mobile terminals having only an omni-directional-antenna capability. With a directional-antenna capability, data packets can be directionally transmitted and acknowledgments can be directionally received by a mobile terminal. A mobile terminal, more particularly, can comprise a wireless phone, a wireless personal digital assistant (wireless PDA), a wireless laptop, or other such communication and/or computing device that connects to or includes a transceiver for transmitting and receiving data packets. As used herein, a data packet denotes a discrete bundle of information. For example, a data packet can comprise bits of encoded data, digitized voice signals, and/or digitized video signal.

The data packets are wirelessly transmitted and received by the nodes 102a-g of the system 100 over wireless channels or links between respective node pairs. An exemplary wireless link 104 is shown connecting the master sending node 102a and corresponding master receiving node 102b, and another exemplary wireless channel or link 106 is shown connecting the slave sending node 102c and corresponding slave receiving node 102d.

At least some of the nodes, including the master sending node 102a and corresponding master receiving node 102b, as well as the slave sending node 102c and corresponding receiving node 102d, can communicate in two operational modes: an omni-directional transmission/reception mode and a directional transmission/reception mode. When operating in the former mode, a node transmits in all directions (i.e., 360 degrees or 2π radians) and/or receives signals from all directions.

The directional antenna can be, for example, a switched single-beam antenna, a steerable single-beam antenna, or other known type of antenna characterized by a capability for radiating and/or receiving electromagnetic waves more effectively in certain directions than in others. The directional antenna can be a sectorized directional antenna, or beamforming antenna. As will be readily understood by one of ordinary skill in the art, a beamforming antenna operates by multiplying a signal with complex weights that adjust the magnitude and phase of a signal transmitted or received by the antenna. This causes the signal to form a transmitting or receiving beam in the desired direction while reducing the signal in other directions. If the complex weights are selected from a library of weights that form beams in specific, predetermined directions, the process is referred to as switched beamforming. Otherwise, if the weights are computed and adaptively updated in real time, the process is referred to as adaptive beamforming. Through adaptive beamforming, the beam can be narrowed towards a desired receiver while its interference with other beams is reduced, thus considerably improving a signal-to-interference-plus-noise ratio.

The system 100 is configured to operate according to a coordinated directional medium access control (CDMAC) protocol. Operating in accordance with this protocol, the transmission and receipt of data packets among the nodes 102a-g is coordinated so as to occur sequentially within a predetermined time-frame structure.

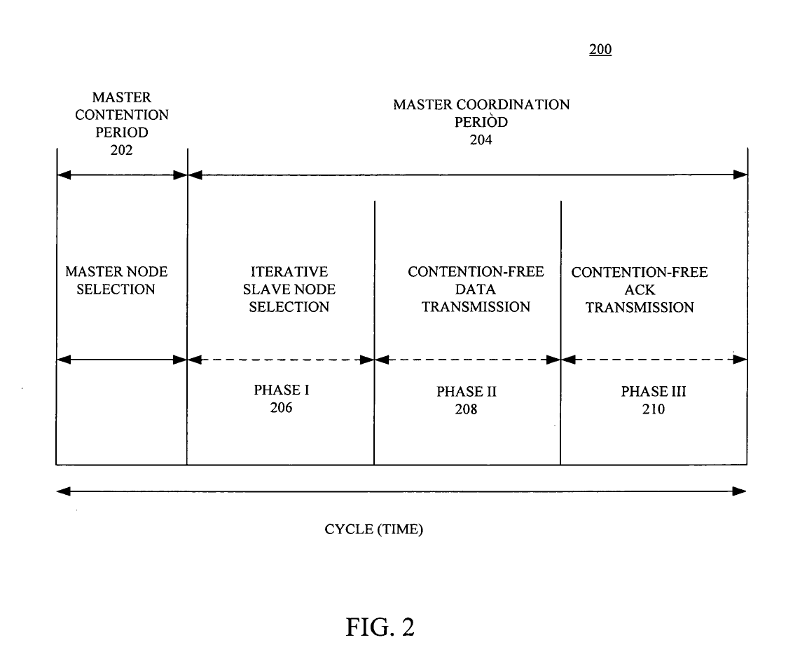

Referring additionally now to FIG. 2, one embodiment of the time-frame structure 200 under which the system 100 operates is schematically illustrated. As explained herein, this particular embodiment pertains to the situation in which the plurality of nodes of the system 100 defines a non-synchronized ad hoc network. The time-frame structure 200 according to this embodiment comprises a first period defining a contention period followed by a subsequent three-phase coordination period.

The first period is designated a master contention period 202 during which various of the nodes of the system 100 are in contention for access to the available channels over which data packets can be transmitted and received. During the master contention period 202, one node is selected as the master sending node 102a and another is selected as a corresponding master receiving node 102b. The master sending node 102a and master receiving node 102b jointly define a master-node pair. For a non-synchronized wireless ad hoc network, as explained herein, the master-node pair set the parameters of the time-frame structure 200.

The second period is designated a master coordination period 204. The master coordination period 204 encompasses a first phase 206 during which slave-node pairs are progressively or iteratively selected from among the remaining nodes that are in contention. The duration of the first phase 206 of master coordination period 204 can be determined by the master node-pair based upon an anticipated number of slave-node pairs, a maximal spatial reuse ratio, and the time that was required for the a node pair to exchange of an RTS and a CTS.

The master-node pair can estimate the anticipated number of slave-node pairs by sensing active nodes—that is, nodes waiting to transmit data packets—in the vicinity of the master node pair. The maximal spatial reuse ratio can be derived by dividing 360 by the width of the main beam of the transmission via the master sending node directional antenna. If the anticipated number of slave-node pairs in the vicinity of the master-node pair is designated as N, if the maximal spatial reuse ratio is designated as M, and if the time for exchanging the RTS and CTS is designated Tctr, then the duration of the first phase 206 of master coordination period 204 can be determined according to the following expression:
Tctr*(min{N, M−1})*C₁,
where C₁ is the value of an adjusting parameter, p, typically greater than one.

If, as discussed below, the one or more pair of slave nodes 102c, 102d is selected using a p-persistent collision resolution algorithm, then the adjusting parameter, p, can be determined according to the following expression:
C₂/N,
wherein 0<C₂<1.

Subsequently, during a second phase 208 of the master coordination period 204, the master sending node 102a and each of one or more slave sending nodes 102c transmits its respective data packet to the corresponding master receiving node 102b and one or more slave receiving nodes 102d, respectively.

The data transmissions occurring within the second phase 208 of the master coordination period 204, as explained herein, are contention-free, parallel (i.e., simultaneous) directional data transmissions. Following the directional data transmissions that occur during the time allocated for the second phase 208, the third phase 210 of the master coordination period 204 occurs. During this third phase 210, contention-free parallel signals are directionally transmitted, these signal acknowledging receipt of the directionally transmitted data transmissions.

The mater-node pair can determine the duration of the second phase 208 of the master coordination period 204 based upon a maximum size of a data packet and a minimum data rate. If the value of the former is designated Lmax and the value of the later is designated basic_rate, then the duration of the second phase 208 of the master coordination period 204 can be determined according to the following expression:
C₃*Lmax/basic_rate,
where, C₃ is a positive integer. The master-node pair further can determine the duration of the third phase 210 of the master coordination period 204 by determining the maximum time needed to transmit an acknowledgement given the data rate, basic_rate.

As already noted, during the contention period, the master sending node 102a and corresponding master receiving node 102b are selected from among various nodes of the system 100 that are in contention for the available channels. More particularly, this selection is in response to an omni-directionally transmitted request-to-send (RTS). The omni-directionally transmitted RTS can be one of a number of such omni-directionally transmitted signals sent by different nodes of the system 100 that are contending for access to the wireless channels over which the nodes communicate during the master contention period 202.

If different nodes are in contention, then the selection of the master sending node 102a and corresponding master receiving node 102b from among the different nodes can be a random selection. According to one embodiment, a contention resolution algorithm such as the exponential-backoff algorithm is used for randomly selecting the master-node pair. More particularly, the different nodes in contention, prior to transmitting a data packet, each randomly selects a backoff interval within a range [0, CW], where CW denotes a predefined value termed a contention window. Based on the randomly selected interval, the node sets a backoff counter. Each such node then reduces seriatim the backoff counter after every idle “slot time” (e.g., a sequential decrement of the counter by one for every time interval equal to the designated slot time). When a particular node's randomly selected backoff counter has been reduced to zero, the node transmits its signal.

If the transmission collides with another signal, then the node doubles the CW, randomly chooses another backoff interval, and repeats the process. With each collision, the CW is doubled until it reaches a maximum threshold, CWₘₐₓ. While waiting to transmit (i.e., while in a backoff state), if a node senses a signal indicating the channel is busy, then the node ceases decrementing its backoff counter and waits until the channel is idle before it resumes decrementing the backoff counter. When a channel is idle for a prescribed duration (e.g., an inter-frame spacing interval such as DIFS), the node continues counting down from its previously frozen backoff counter value. When a node receives a clear-to-send (CTS) in response to its RTS, it is an indication that no collision with another signal has occurred and that the node has been successful in reserving a channel for the later transmission of a data packet; that node and the corresponding node from which the CTS was received are selected as the master sending node 102a and corresponding master receiving node 102b.

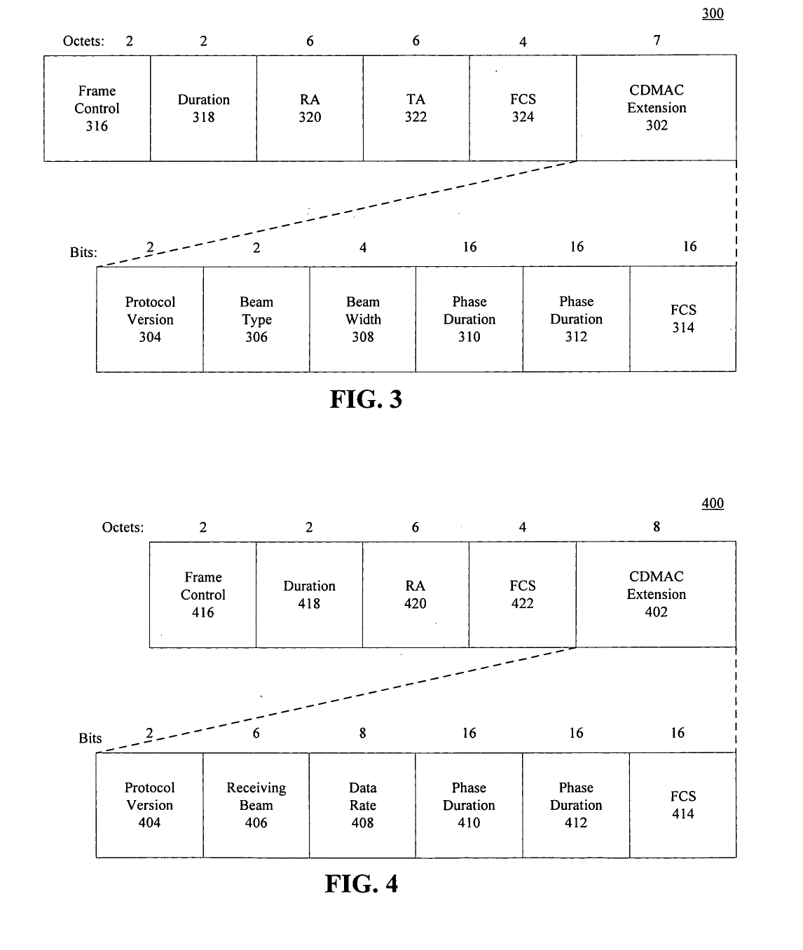

Referring additionally now to FIG. 3, the structure of a packet comprising an RTS frame 300 according to one embodiment is illustrated. The RTS frame 300 is a control frame that can be conveyed by a wireless carrier wave or signal. The RTS frame 300 illustratively includes a CDMAC extension 302. CDMAC extension 302 illustratively comprises a two-bit field 304 that designates a protocol version. A contiguous two-bit field 306 indicates a beam type and is applicable if the antenna type used by the nodes is a beamforming type as described above. For example, a “00” can indicate switched beamforming is to be utilized, while a “01” can indicate adaptive beamforming is to be utilized (“01” and “11” can be reserved for future use). The following four-bit field 308 designates the width of the directional beam to be utilized when the node is engaged in directional data-packet transmissions.

The two 16-bit fields 310, 312 designate, respectively, the durations of the first and second phases 206, 208 of the three-phase master coordination period 204. As explained below, these durations establish the time for receiving a CTS signal (e.g., the time for receiving the CTS time plus two times a conventional time interval such as a short inter-frame space or SIFS) plus that of the coordination period 204. The duration values indicated in the designated fields 318, 310, 312 and 418, 410, 412 can be used by all the nodes (omni-directional-limited nodes as well as directional-capable nodes) to set a network allocation vector (NAV), which establishes the time period during which no transmissions are initiated even if no traffic is sensed by the nodes. The duration fields 310, 312 are illustratively followed by a frame check sequence (FCS) 314 or error detection field.

Illustratively, the CDMAC extension 302 is appended to the fields 316-322 of a frame constructed according to a standard medium access control (MAC) protocol such as the IEEE 802.11 protocol, these frames making up the rest of the RTS frame 300 according to an embodiment of the present invention. Because the nodes of the system 100, as already described, can communicate as omni-directional-antenna-based wireless devices as well as directional-antenna-capable wireless devices, the system 100 is backward compatible with the IEEE 802.11 protocol. Accordingly, the RTS frame 300 including the CDMAC extension 302 extends conventional protocols such as the IEEE 802.11 protocol. As further described herein, the CDMAC extension 302 can be utilized to effect the procedural steps undertaken by the system 100 in order to attain capabilities not currently available with the IEEE 802.11 or other conventional protocols.

Referring additionally now to FIG. 4, a structure of a packet comprising a corresponding CTS frame 400 according to another embodiment is illustrated. The CTS frame 400 is also a control frame that can be conveyed by wireless carrier wave or signal. As illustrated, the CTS frame 400 similarly includes a CDMAC extension 402. The CDMAC extension 402 illustratively comprises a two-bit protocol version field 404. Additionally, the CDMAC extension 402 of the CTS frame 400 illustratively includes a six-bit field 406 that designates the direction of the receiving beam, the direction being determined as described below. Next is an eight-bit field 408 that designates a data rate for the transmission of data packets, the data rate being determined as also described below. The following two 16-bit fields 410, 412 designate, respectively, the durations of the first and second phases 206, 208 of the three-phase master coordination period 204. The two 16-bit fields 410, 412 are copied from the 16-bit duration fields 310, 312 of the RTS frame 300. These two durations together with the time for the master coordination period 204 establish the starting and ending times of each phase of the coordination period.

Operatively, the RTS 300 is transmitted from the master sending node 102a to the master receiving node 102b. Upon receiving the RTS 300 the master receiving node 102b determines a direction from which the master sending node 102a should directionally transmit a data packet to the master receiving node. The direction is indicated by the direction of a receiving beam corresponding to the directional transmission that is to be received by the master receiving node 102b from the master sending node 102a. According to one embodiment, the master receiving node 102b determines the direction based upon the angle at which the signal or carrier wave by which the RTS is transmitted arrives at the master receiving node. Once determined, the direction is designated in the six-bit field 406 of the CTS frame 400 designated for the receiving beam, as described above.

The master receiving node 102b further determines the data rate at which the data packet is to be directionally transmitted from the master sending node 102a. The master receiving node 102b determines the data rate based upon a signal-to-noise ratio (SNR) of the omni-directional signal or carrier wave by which the RTS frame 300 is transmitted by the master sending node 102a. The data rate can also be determined on the basis of a measured directional antenna gain. Once determined, the data rate is designated in the eight-bit field 408 of the CTS frame 400 as also described above.

Before the contention period 202 is concluded, the CTS frame 400 is omni-directionally transmitted by the master receiving node 102b. The CTS frame 400 is received by the master sending node 102a as well as other nodes of the system 100 that were also in contention for access to the wireless channels. The master sending node 102a, in the second phase 208 of the master coordination period 204, will directionally transmit its data packet to the master receiving node 102b in the direction and at the data rate specified in the CTS frame 400. Before the second phase 208 begins, however, the first phase 206 of the coordination period 204 must be completed.

The first phase 206 of the master coordination period 204 begins when the master contention period 202 concludes. The one or more pairs of nodes that were in contention during the master contention period 202, now contend for channel access in the first phase 206 of the master coordination period 204, each pair now vying to be the first pair selected as a slave sending node 102c and corresponding slave receiving node 102d. Each such pair of contending nodes, having received during the master contention period 202 the omni-directionally transmitted CTS frame 400, knows the particular beam direction along which the master sending node 102a will directionally transmit its data packet to the master sending node 102b in the second phase 208 that has yet to commence. Accordingly, the system 100 precludes those node pairs whose directional data transmissions would interfere with that of the master nodes 102a, 102b from being selected as slave nodes.

Any pair of nodes whose directional data transmissions would not interfere with the directional data transmission between the master nodes 102a, 102b is eligible for selection as a slave sending node 102c and corresponding slave receiving node 102d. If more than one pair of nodes of the system 100 are in contention, then the selection can again be a random-based selection according to a contention resolution algorithm. As will be readily understood by one of ordinary skill in the art, a p-persistent algorithm senses whether a channel is idle, and if so transmits with a probability p. If the channel is busy, the node waits one time slot. If transmission does occur and results in a collision, the node waits until the channel becomes idle and then repeats the process. Other collision resolution algorithms can similarly be used, both for the selection of the master nodes as well as the slave nodes.

More than one pair of slave nodes can be selected. The selection of additional slave-node pairs can be performed progressively or iteratively according to the criteria already described, namely, that any pair of nodes selected as additional slave nodes be ones whose directional data transmissions will not interfere with the directional data transmissions of the master nodes 102a, 102b and any other pair of already-selected slave nodes.

According to yet another embodiment, the system 100 imposes a further constraint on the selection of slave-node pairs during the first phase 206 of the master coordination period 204. A node that is a candidate to be selected by the system 100 as a slave sending node firstly must not anticipate directionally transmitting to a corresponding slave receiving node so as to interfere with the directional signaling between the master nodes 102a, 102b, as already noted, or interfere with directional signaling between any earlier-selected pair of slave nodes.

Secondly, however, under the additional constraint, a candidate for selection as a slave sending node can not be positioned so close to either of the master nodes 102a, 102b or either one of an already-selected slave-node pair that a side lobe of a directional transmission from the candidate would interfere with a directional transmission between the other nodes. As noted already, a side lobe constitutes that portion of the electromagnetic response pattern of an antenna that is not contained in the main beam of a directional signal. The candidate for selection as a slave node, under this second criterion, thus can not be within a side-interference region of any other node, lest a side lobe of a directional transmission of the candidate interfere with the receipt of a directionally transmitted signal between any other two nodes.

According to one embodiment, the determination of whether a candidate for selection as a slave node lies within side-interference region is based upon the power of the signals by which the RTS frame 300 and CTS frame 400 are conveyed. If the power of a received signal is greater than a predetermined threshold, it indicates that the candidate node, were it to engage as a slave sending node in directionally transmitting to a slave receiving node, would likely interfere with the directional transmission between another pair of nodes. Therefore, the system 100 excludes the candidate from selection as a slave node under the additional condition, according to this particular embodiment. The predetermined threshold can be calculated, for example, as γ(Gₒ/Gₛ)², where Gₛ is a side lobe beam gain, Gₒ is the omni-directional antenna gain, and γ is the carrier sense threshold for power of a signal received via the omni-directional antenna.

Each acknowledgement from a master or slave receiving node that receives a data packet is conveyed in a direction opposite to the beam direction of the signal by which the data packet was received. It follows, therefore, that the directional transmission of corresponding acknowledgements is likely to be collision free since the system 100 precludes the selection of any node as a slave sending node if that node's directional transmission of data packets would interfere with the directional transmissions of data packets between the master nodes or any earlier-selected pair of slave nodes. That is, the above-described operation of the system 100, which precludes the selection of a node as a slave sending node if a directional transmission of a data packet by that node would cause a collision, has the added benefit of avoiding collisions between signals conveying acknowledgements during the third and final phase 210 of the coordination period. No explicit operations beyond those already described need be undertaken in order to avoid collisions between directionally transmitted acknowledgements.

According to still another embodiment, each candidate for selection as a slave node that is in contention for access to the available channels receives an omni-directionally transmitted CTS frame 400 from other nodes, and caches the receiving beam information contained in the six-bit field 406 of the CTS frame. With the selection of each new pair of slave nodes, the information is updated and cached by each such candidate vying for access to an available channel. The cached information provides an indication of whether channel resources of the network can permit yet another directional signaling between two additional slave nodes according to the determinations already described. If so, a candidate omni-directionally transmits an RTS, and, if no collision with transmissions between already-selected nodes occurs, the intended recipient responds with an omni-directionally transmitted CTS signal. The responsive CTS frame 400 conveyed by the signal, as already noted, includes a bit field 406 that specifies a beam direction for the anticipated directional transmissions of a data packet and corresponding acknowledgement.

Nonetheless, the cached information can be inaccurate owing to the mobility of either a sending or receiving node. Accordingly, one of two events can occur if movement of the sending or receiving node causes an alteration in the beam direction between the two nodes: either the resulting new beam direction for directional signaling between the nodes is one already reserved by the master nodes or an earlier-selected pair of slave nodes, or the resulting new beam is nonetheless still available. If the first event occurs, then the slave receiving node responds with a CTS setting the receiving beam field 406 of the CTS frame 400 to “11XXXXXX,” the first two bits denoting that the beam has previously been reserved and the remaining six bits denoting the resulting beam. Upon receipt of the CTS frame 400, the slave sending node can update its cached information accordingly. If, however, the resulting beam is one that is still available, then the receiving beam field 406 of the CTS frame 400 is set to a value indicating the resulting new beam direction.

It should be noted that the system 100 also can allow a slave sending node to utilize multi-user diversity whenever it has several queued packets that are designated for transmitting to multiple slave receiving nodes. That is, the system 100 can permit such a slave sending node to still contend for access to available channels even if some targeted slave receiving nodes lie along beams no longer available to the slave sending node.

According to yet another embodiment, the master sending node 102a as well as any slave sending nodes can determine how many bursty packets to transmit. The maximum number of bursty packets can be determined based upon an average packet size associated with a specific pair of nodes and an achievable data rate, where, in turn the achievable data rate is based upon a data rate determined according to a node's directional antenna gain and the SNR of an RTS received by a node. If the average packet size is designated as Lavg, and if the achievable data rate is designated achievable_rate, then the maximum number of bursty packets is determined according to the following expression:
achievable_rate*C₄*(Lmax/basic_rate)/Lavg,
wherein Lmax designates, as above, a maximum packet size, and basic_rate, also as above, designates a minimum data rate. C₄ is a positive integer.

The determination of how many bursty packets to transmit can be made at the outset of the second phase 208 of the coordination period 204 and can be based, for example, on the data rate indicated in the data rate fields 408 of the CTS frames 400 received from the master receiving node 102b and any corresponding slave receiving nodes. The determination also can be based on the length of the parallel data packets to be directionally transmitted and on the number of packets that are queued for transmission.

Even though the system 100 operationally provides a high probability that directional transmission and reception of data packets will be collision free, an added safeguard for ensuring reliable transmission and receipt of data packets is the acknowledgement signal transmitted by the master receiving node 102b and any slave receiving node 102d that receives a directionally transmitted data packet. Nonetheless, signaling overhead can be further reduced, according to another embodiment, if an accumulated acknowledgement is utilized. Thus, in the third and final phase 210 of the coordination period 204, each node that has in the previous phase correctly received one or more directionally transmitted data packets responds by transmitting a single, accumulated acknowledgement. The length of the third phase 210 can be set accordingly so that the phase permits the directional transmission of one acknowledgement.

The potential for a hidden terminal problem can be further mitigated according to another embodiment. According to this embodiment, a special directional RTS can be transmitted by the master sending node 102a immediately following the exchange of an RTS and CTS between the master sending nod and corresponding master receiving node 102b. The special RTS is transmitted along a beam opposite the direction of that between the master sending node 102a and the master receiving node 102b randomly selected as described above. Similarly, a special directional RTS can be transmitted by a slave sending node 102c selected following the selection of the slave-node pair as also described above.

Further according to this embodiment, a special directional CTS can be transmitted by the master receiving node 102b and by a slave receiving node 102d, respectively, following the successful exchange of an RTS and CTS between the master-node pair and a slave-node pair. The transmission range of the special directional RTS and that of the special directional CTS are sufficiently larger than the transmission range of the omni-directionally transmitted RTS and CTS signals such that, in the specific directions of the directional transmissions, there is little or no risk of interference from any of the omni-directionally transmitted signals. Accordingly, the transmissions of these special signals, as will be readily understood by one skilled in the art, can mitigate the risk of a hidden terminal problem.

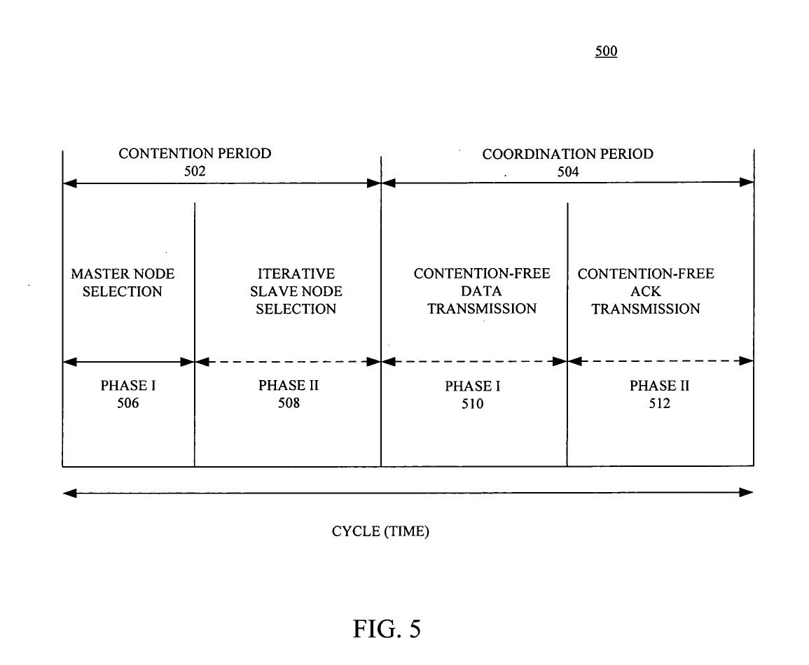

Yet another embodiment of the present invention pertains to the situation in which the plurality of nodes of the system 100 define a synchronized ad hoc network. A time-frame structure 500 according to this embodiment is illustrated in FIG. 5. The time-frame structure comprises a first two-phase period, defining a contention period 502, followed by a subsequent two-phase period, defining a coordination period 504.

During a first phase 506 of the contention period 502 the master receiving node 102a and corresponding master sending node 102b are each automatically selected from among the plurality of nodes of the system 100 in response to an omni-directionally transmitted RTS and omni-directionally transmitted CTS exchanged by pairs of the nodes. Again, the master sending node 102a and master receiving node 102b selected from among the plurality of nodes jointly define a master-node pair. The master-node pair, moreover, can be selected randomly according to any of the procedures already described, including according to an exponential backoff or p-persistent contention resolution algorithm.

The first phase 506 of the contention period 502 ends upon the selection of the master-node pair. The selection of the master-node pair initiates the second phase 508 of the contention period 502. During the second phase 508 of the contention period 502, at least one slave sending node 102c and corresponding slave receiving node 102d can be selected from among the remaining nodes of the system 100 based, again, on the exchange between each pair of nodes of an omni-directionally transmitted RTS and omni-directionally transmitted CTS. Any pair of nodes selected as a slave sending node and corresponding slave receiving node must satisfy two criteria. The spatial reuse ratio associated with the master-node pair must be less than a predetermined threshold and directional data transmissions that would occur between the slave sending node and corresponding slave receiving node must avoid interfering with directional data transmissions between the master nodes and any other pairs of slave nodes already selected.

The one or more pairs of slave sending and slave receiving nodes 102c, 102d likewise can be selected according to any of the slave node selection procedures described already. These procedures include, for example, the random selection of one or more slave-node pairs during the second phase 508 of the contention period 502. A random selection can be made, moreover, according to an exponential backoff or p-persistent backoff algorithm, for example. For the synchronized wireless ad hoc network, the starting time of the first phase 506 and the ending time of the second phase 508 of the contention period 502 initiated by the selection of a master-node pair can be predetermined by the system.

Further according to this embodiment, once the master nodes and one or more pairs of slave nodes have been selected during the two-phase contention period 502, the subsequent two-phase coordination period 504 begins. The master sending node 102a and at least one slave sending node 102c each directionally transmit at least one data packet during a first phase 510 of the coordination period 504. Again, since the wireless ad hoc network is synchronized, the beginning and ending times of this first phase 510 of the coordination period are predetermined by the system.

Finally, any of the master receiving node 102b and/or at least one slave receiving node 102d that have received a data packet during the first phase 510, acknowledge the receiving during the second phase 512 of the two-phase coordination period 504. Each acknowledgement is directionally transmitted during the second phase 512.

According to this embodiment, the duration of the contention period 502 can be set equal to C₅*Tctr{min[Navg, M]}, where C₅ is the value of an adjusting parameter, p, typically greater than one, Navg is an average number of active node pairs in a local area, and M is, as above, a maximal spatial reuse ration. The local area, moreover, can be defined as a circular area having a radius equal to the transmission/reception range of an omni-directional antenna. If contention among all the nodes, master as well as slave, is resolved according to the p-persistent algorithm described above, then the parameter p can be set as C₆/Navg, where C₆ typically lies in the range from zero to one.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

We claim:

1. A method for coordinating the transmitting and receiving of data packets over wireless channels by a plurality of nodes defining a wireless network, the method comprising:
during a contention period, automatically selecting from among the plurality of nodes a master sending node and corresponding master receiving node in response to an omni-directionally transmitted request to send, the master sending and receiving nodes defining a master-node pair;
selecting from among remaining ones of the plurality of nodes at least one slave sending node and corresponding slave receiving node if a spatial reuse ratio associated with the master-node pair is less than a predetermined threshold and if directional data transmissions between the slave sending node and corresponding slave receiving node avoid interfering with directional data transmissions between the master nodes and other pairs of slave nodes; and
during a coordination period, causing the master sending node and at least one slave sending node to each directionally transmit at least one data packet.

2. The method of claim 1, further comprising causing the master receiving node and at least one corresponding slave receiving node to each respond to receiving a data packet by directionally transmitting an acknowledgement during the coordination period.

3. The method of claim 1, wherein the wireless network comprises a non-synchronized ad hoc network, and wherein the contention period comprises a master contention period and the coordination period comprises a master coordination period.

4. The method of claim 3, wherein the selecting of the slave sending node and slave receiving node occurs during a first phase of the master coordination period, wherein directional transmission of at least one data packet by each of the master sending node and at least one slave sending node occurs during a second phase of the master coordination period, and further comprising causing the master receiving node and at least one corresponding slave receiving node to each respond to receiving a data packet by directionally transmitting an acknowledgement during a third phase of the master coordination period.

5. The method of claim 1, the wireless network defining a synchronized ad hoc network, wherein the selecting of at least one slave sending node and corresponding slave receiving node occurs during a predetermined second phase of the contention period, and wherein the master sending node and at least one slave sending node each directionally transmit at least one data packet during a predetermined first phase of the coordination period.

6. The method of claim 5, further comprising causing the master receiving node and at least one corresponding slave receiving node to each respond to receiving a data packet by directionally transmitting an acknowledgement during a predetermined second phase of the coordination period.

7. The method of claim 1, further comprising determining a data rate and a beam direction for directional data transmissions between the master sending node and corresponding master receiving node.

8. The method of claim 7, wherein the beam direction is determined based upon an angle at which the omni-directionally transmitted request to send is received at the master receiving node.

9. The method of claim 7, wherein the data rate is determined based upon at least one of a signal-to-noise ratio (SNR) of the omni-directionally transmitted request to send and a directional antenna gain associated with the directional antenna.

10. The method of claim 7, wherein determining whether a directional data transmission between the at least one slave sending node and corresponding slave receiving node avoids interfering with directional data transmissions between the master nodes and between pairs of other slave nodes comprises determining whether a beam direction of a directional data transmission between the at least one slave sending node and corresponding slave receiving node would intersect at least one beam direction of directional data transmissions between the master nodes and between other slave nodes.

11. The method of claim 10, wherein determining whether a directional data transmission between the at least one slave sending node and corresponding slave receiving node avoids interfering with directional data transmissions between the master nodes and between pairs of other slave nodes further comprises determining whether at least one slave node is within a side-interference region of at least one master node or at least one slave node.

12. The method of claim 11, wherein the determination of whether at least one slave node is within a side-interference region is based upon a side lobe beam gain, Gₛ, and an omni-directional antenna gain, Gₒ, according to the expression γ(Gₒ/Gₛ)², where γ is a carrier sense threshold for power of a signal received via an omni-directional antenna.

13. The method of claim 1, wherein selecting the master sending node comprises randomly selecting one of the plurality of nodes that is in contention with at least one other of the plurality of nodes for access to the wireless channels.

14. The method of claim 13, wherein the master node is randomly selected based upon a contention resolution algorithm.

15. The method of claim 1, wherein selecting the at least one slave sending node comprises iteratively selecting a first slave sending node if a directional data transmission between the slave sending node and its corresponding slave receiving node avoids interfering with a directional data transmission between the master sending node and corresponding master receiving node, and selecting a second slave sending node if a directional data transmission between the second slave sending node and second slave receiving node avoids interfering with a directional data transmission between the master sending node and corresponding master receiving node and avoids interfering with a directional data transmission between the first slave sending node and first corresponding receiving node.

16. The method of claim 1, further comprising determining a number of bursty packets to be transmitted during the coordination period, the determination being based upon data rate derived from at least one of a signal-to-noise ratio (SNR) and a directional antenna gain.

17. The method of claim 1, wherein at least one of the master sending node and the at least one slave sending node transmit a special RTS, and wherein at least one of the master receiving node and the at least one corresponding slave receiving node transmit a special CTS in response to a received RTS.

18. The method of claim 1, further comprising causing the at least one slave receiving node to respond to a change in the beam direction between itself and its corresponding slave sending node by informing its corresponding slave sending node whether a new beam direction between the at least one slave receiving node and its corresponding slave sending is available.

19. The method of claim 1, further comprising causing a node having only omni-directional data transmission capabilities to remain silent during the coordination period whenever the network includes at least one node having only omni-directional data transmission capabilities.

20. A system for wirelessly transmitting and receiving data packets in a wireless network, the system comprising:
a master sending node and corresponding master receiving node automatically selected from a plurality of nodes during a contention period in which the master sending node omni-directionally transmits a request-to-send frame and the master receiving node responds to the request-to-send frame by omni-directionally transmitting a clear-to-send frame; and
at least one slave sending node and corresponding slave receiving node selected from others of the plurality of nodes, the at least one slave sending node omni-directionally transmitting another request-to-send frame and the corresponding slave receiving node responds by omni-directionally transmitting another clear-to-send frame;
wherein during a second phase of a coordination period each of the master sending node and at least one slave sending node directionally transmits at least one data packet.

21. The system of claim 20, wherein the master receiving node is configured to determine a data rate and a beam direction for directional data transmissions between the master sending node and corresponding master receiving node.

22. The system of claim 21, wherein the master receiving node is configured to determine the beam direction based upon an angle at which the omni-directionally transmitted request to send signal is received at the master receiving node.

23. The system of claim 20, wherein each slave node is configured to cache receiving beam information that indicates whether a directional transmission between a sending slave node and receiving slave node will interfere with a directional transmission between the master nodes or other pair of slave nodes.

24. The system of claim 20, wherein each master node and each slave node is configured to respond to receiving a plurality of data packets with an accumulated acknowledgement.

25. A set of control frames embodied in carrier signals, comprising:
an request-to-send (RTS) frame comprising a coordinated directional medium access control (CDMAC) extension; and
a clear-to-send (CTS) frame comprising a coordinated directional medium access control extension.

26. The set of control frames of claim 25, wherein each (CDMAC) extension is based upon a time-frame structure comprising a contention period and a three-phase coordination period.
